(19) United States
(12) Patent Application Publication
(10) Pub. No.: US 2023/0038796 A1
(43) Pub. Date: Feb. 9, 2023

(54) AUTOMATED GENERATION OF PRIVACY AUDIT REPORTS FOR WEB APPLICATIONS

(71) Applicant: Intuit Inc., Mountain View, CA (US)

(72) Inventors: Sandeep Bhatkar, Sunnyvale, CA (US); Swapnil Bhalode, Fremont, CA (US); Siddhesh Yawalkar, Fremont, CA (US); Hemant Puri, Fremont, CA (US); Deepika Dhruv Gajaria, Campbell, CA (US); Surabhi Sinha, San Jose, CA (US); Nicholas Maxwell, Fremont, CA (US); Michael S. Rogers, Aldie, VA (US)

(21) Appl. No.: 17/881,377

(22) Filed: Aug. 4, 2022

Related U.S. Application Data
(60) Provisional application No. 63/229,357, filed on Aug. 4, 2021.

(51) Int. Cl. G06F 11/07; G06F 11/36

(52) U.S. Cl. CPC G06F 11/0781; G06F 11/362

(57) ABSTRACT

Various embodiments comprise systems and methods to generate privacy audit reports for web applications. In some examples a computing system comprises a data extraction component, a risk assessment component, and an exposure component. The data extraction component crawls a web application and identifies data, data exposure points, and security policies implemented by the web application. The risk assessment component generates a risk score for the web application based on the amount data, the data sensitivity, the amount and type of data exposure points, and the security policies. The risk assessment component generates the privacy audit report for the web application. The privacy audit report comprises the risk score, an inventory of data types, an inventory of the data exposure points, and a graphical representation of historical risk scores. The exposure component transfers the privacy audit report for delivery to an operator of the web application.

### RELATED APPLICATIONS

This U.S. Patent application claims the benefit of, and priority to, U.S. Provisional Patent Application 63/229,357, entitled “AN AUTOMATED WAY TO GENERATE A PRIVACY AUDIT REPORT FOR WEB APPLICATIONS”, filed on Aug. 4, 2021, which is hereby incorporated by reference into this U.S. Patent Application in its entirety for all purposes.

### TECHNICAL BACKGROUND

Modern web applications integrate code and other resources from dozens of third-party service providers, including content delivery networks (CDNs) and third-party JavaScript libraries. A significant portion of this content comprises executable scripts with direct security impact on a website. For example, recent breaches of user data on many popular websites have been attributed to compromised third-party JavaScript files. Advanced web architectures typically rely heavily on JavaScript and enabling third-party code to perform client-side network requests. These innovations are built on client-heavy frameworks that leverage the processing power of the client device to enable the execution of code directly on the web browser. Today, it is not uncommon for a majority of the code executing and rendering on a client browser to come from such integrations. All of these software integrations provide avenues for potential vulnerabilities. Web browser standards such as content security policy (CSP) can help to prevent exploitation of such vulnerabilities.

Cybercriminals often attack websites for malicious purposes such as stealing data, site defacement, crypto-jacking, and clickjacking. CSP is a web standard that is designed to block techniques such as cross-site scripting (XSS) and code injection used by these attacks. To enable CSP, a web server is configured to return a CSP response header with a policy that encodes valid web application behavior. This allows a web browser to block and report any behavior that does not conform to the policy. Moreover, web applications must adhere to a number of privacy regulations like General Data Protection Regulation (GDPR), California Consumer Privacy Act (CCPA), Health Insurance Portability and Accountability Act (HIPPA) that regulate what and how user data can be exposed. The risk of cyber-attacks and the amount privacy regulations compounds the difficulty that web applications face in accounting for and securing user data. Unfortunately, web applications do not effectively track third-party exposure of user data. Moreover, web applications do not efficiently assess the exposure risk of user data associated with the applications.

### OVERVIEW

Various embodiments of the present technology generally relate to solutions for providing security to web applications. Some embodiments comprise a system to generate a privacy audit report for a web application. The system comprises a memory that stores executable components and a processor operatively coupled to the memory. The processors executes the executable components. The executable components comprise a data extraction component, a risk assessment component, and an exposure component. The data extraction component crawls the web application and identifies data in the web application, data exposure points in the web application, and security policies implemented by the web application. The risk assessment component generates a risk score for the web application based on the amount of the data, the sensitivity of the data, the amount and type of the data exposure points, and the security policies. The risk assessment component generates the privacy audit report for the web application. The privacy audit report comprises the risk score, an inventory of data types, an inventory of the data exposure points, and a graphical representation of historical risk scores. The exposure component transfers the privacy audit report for delivery to an operator of the web application.

Some embodiments comprise a method to generate a privacy audit report for a web application. The method includes crawling, by a system comprising a processor, the web application and identifying data, data exposure points, and security policies in the web application. The method continues by generating, by the system, a risk score for the web application based on the amount of the data, the sensitivity of the data, the amount and type of the data exposure points, and the security policies. The method continues by generating, by the system, the privacy audit report for the web application. The privacy audit report comprises the risk score, an inventory of data types, an inventory of the data exposure points, and a graphical representation of historical risk scores. The method continues by transferring, by the system, the privacy audit report for delivery to an operator of the web application.

Some embodiments comprise a non-transitory computer-readable medium storing instructions to generate a privacy audit report for a web application. The instructions, in response to execution, cause a system comprising a processor to perform operations. The operations comprise crawling the web application. The operations further comprise identifying data in the web application. The operations further comprise identifying data exposure points in the web application. The operations further comprise identifying security policies implemented by the web application. The operations further comprise generating a risk score for the web application based on the amount of data, the sensitivity of the data, the amount of data exposure points, the type of the data exposure points, and the security policies. The operations further comprise generating the privacy audit report for the web application that comprises the risk score, an inventory of data types, an inventory of the data exposure points, and a graphical representation of historical risk scores. The operations further comprise transferring the privacy audit report for delivery to an operator of the web application.

### BRIEF DESCRIPTION OF THE DRAWINGS

Many aspects of the disclosure can be better understood with reference to the following drawings. The components in the drawings are not necessarily drawn to sale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an exemplary block diagram to generate a privacy audit report.

FIG. 2 illustrates an exemplary process to generate a privacy audit report.

FIG. 3 illustrates an exemplary process to generate a privacy audit report.

FIG. 4 illustrates an exemplary block diagram to generate a privacy audit report.

FIG. 5 illustrates a user interface according to some embodiments of the present technology.

FIG. 6 illustrates an exemplary computing device that may be used in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Web applications integrate code, scripts, and other resources from many different third-party service providers, including content delivery networks (CDNs) and third-party JavaScript libraries. For example, JavaScript code can be loaded as an inline script, or through a uniform resource locator (URL) to an external script source. Content security policy (CSP) is a widely supported web standard for preventing cross-site scripting (XSS) and code injection attacks. CSP provides a mechanism for website owners to specify the origins of allowed executable scripts and other code on their website, such as JavaScript files, images, and other web resources. For example, a security policy may be specified by providing an inventory that lists all of the trusted sources that host the various resources of the website, such as the domain names or URLs of the valid third-party hosts from which the client browser can download legitimate JavaScript files, fonts, images, embeddable objects, and other web content. This list of valid resources is typically provided as a security policy in a CSP response header that is received by a user's web browser when the user visits a website. The client web browser analyzes the CSP header and verifies that the web application is behaving according to the security policy specified in the CSP header, meaning that the web application is only accessing the resources from the valid origins listed in the policy. If the web browser determines that the web application is attempting to load any resource from a source that is not specified in the CSP header, then this action is blocked and identified as a violation of the policy.

Although CSP provides an effective way to monitor and analyze the policy violations that are occurring at the client-side browsers, the privacy controls are often unable to ensure full compliance with privacy regulations for the web applications. Websites today are key participants in collecting consumer data. Consumers are interacting with web applications for commerce, banking social media services, and the like. The interactions often cause the consumers to enter sensitive information that can identify them like name, username/password, address, and the like. Websites today also need to be keenly aware of who they are sharing customer information with. In some examples, less than a third of the code on a web application is native to the website and more than two thirds is fetched from 3rd parties for applications such as tag management, analytics tools, social media, and the like. Each vendor integration may also have access to data collected on their site. Given this paradigm shift in web architecture, there is a gap in the tools available to enterprises to index, monitor and audit their website vendors' access to sensitive information. With the number of privacy regulations (GDPR, CCPA, HIPAA etc.) enterprises need to adhere to, there is still a gap in the web application data collection and monitoring space. There are tools available that tackle specifically how data collected by enterprises is stored within their back-end databases, who in the organization have access to data and so forth but lack the insights into website data risks. The technology described herein includes a method to calculate and report on the current privacy assurance risk with a Privacy Audit report for a web application, as well as tangible recommendations and controls to minimize the risk.

Various embodiments of the present technology comprise automated methods to identify all the current security and privacy controls and their robustness, including but not limited to, CSP, HSTS, x-Content type headers, SRI, Referrer policy, permissions policy, and the like. The methods may include automated detection of data flow that is resilient to common forms of obfuscation over network, cookies, local storage, URL parameters and even memory in a JavaScript execution environment. Some embodiments include methods for identifying sensitive data flow (DLP definition) in forms, cookies, storage, trackers via synthetic transactions and identifying the mechanism of data exposure and leakage via network requests and via a crawl via the cloud which results in limited performance impact to users and not implementation of a crawler. Some embodiments comprise methods to quantify and categorize the level of sensitive data risk (read, access, leaked) across the web application based on extrapolating contextual information (forms with sensitive data fields, number of third-party integration with access to sensitive data etc.) into the data risk calculation. Some embodiments comprise methods to evaluate suboptimal cookie characteristics for minimal data access and tracking (insecure cookies, same site restrictions etc.) and incorporate into the data risk score. Some embodiments comprise methods to identify the third-party integrations on the site and the vendors reputation and to classify data shared to third parties, as potentially sensitive based on page characteristics (contextual data on the form, vendor integrations on the site). Some embodiments comprise methods to identify cookie consent banners for users and ensure all permutations and combinations of preferences are honored per user selection. Deviations in honoring preferences are highlighted along with the source of the oversight. Some embodiments comprises methods to account for vendor-data mapping based on user input to monitor and alert for changes authorized or unauthorized. Some embodiments comprise methods to track vendor/third party data flow mapping across data access, exposure and leakage mechanisms and utilize this information to alert on changes in the vendor to data flow over time, based on a baseline measurement and automated methods for scoring of the privacy practices of a website using an analysis of sensitive data exposure and the strength of controls in place.

Various embodiments of the present technology relate to solutions for assessing the privacy risk for user data in web applications. More specifically, embodiments of the present technology relate to systems and methods for scanning web applications and generating privacy audit reports that characterize the privacy risk for user data on web applications. Now referring to the Figures.

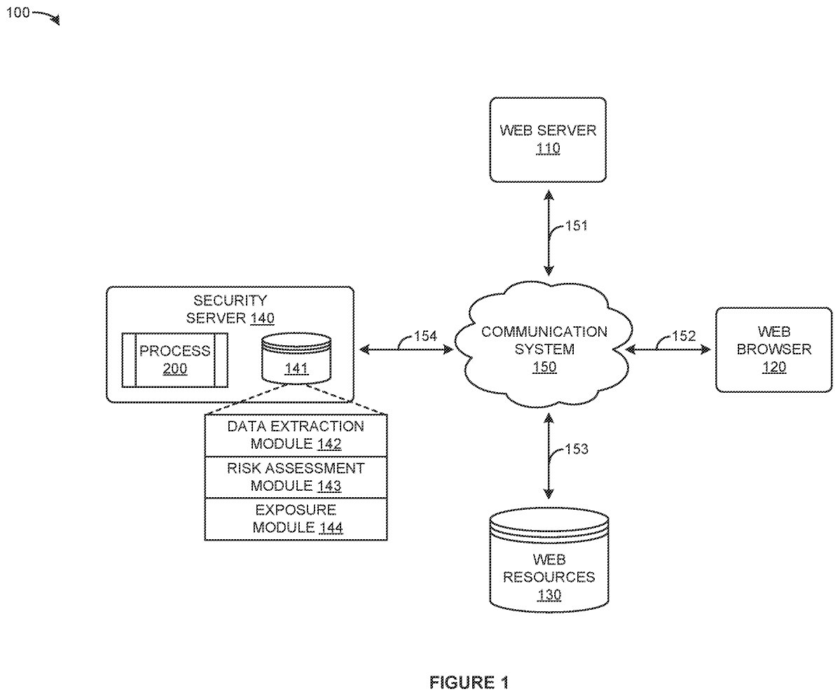

FIG. 1 illustrates communication network 100 to generate privacy audit reports for a web application. Communication network 100 provides services like online networking, content distribution, web application services, web application security, and the like. Communication network 100 comprises web server 110, web browser 120, web resource 130, security server 140, communication system 150, and communication links 151-154. Security server 140 comprises process 200 and modules 141. Modules 141 include data extraction module 142, risk assessment module 143, and exposure module 144. In other examples, communication network 100 may include fewer or additional components than those illustrated in FIG. 1. Likewise, the illustrated components of communication network 100 may include fewer or additional components, assets, or connections than shown. Each of web server 110, web browser 120, web resources 130, security server 140, and communication system 150 may be representative of a single computing apparatus or multiple computing apparatuses.

Web server 110 is representative of one or more computing devices configured to provide web applications to web browser 120. Web server 110 may comprise a server, a Content Distribution Network (CDN), a reverse proxy, a load balancer, or any other computing system or network equipment. Web server 110 may comprise a system that provides a cloud-based web service. Web server 110 may be representative of any computing apparatus, system, or systems that may connect to another computing system over a communication network. Web server 110 comprises a processing system and communication transceiver. Web server 110 may also include other components such as a router, server, data storage system, and power supply. Web server 110 may reside in a single device or may be distributed across multiple devices. Web server 110 may be a discrete system or may be integrated within other systems, including other systems within communication network 100. Some examples of web server 110 include database systems, desktop computers, server computers, cloud computing platforms, and virtual machines, as well as any other type of computing system, variation, or combination thereof. In some examples, web server 110 could comprise a network security appliance, firewall, CDN, reverse proxy, load balancer, middleware, cloud server, intrusion prevention system, web application firewall, web server, network switch, router, switching system, packet gateway, network gateway system, Internet access node, application server, database system, service node, or some other communication system, including combinations thereof.

Web browser 120 is loaded on and executed by various computing systems, including any computing apparatus, system, or systems that may connect to another computing system over a communication network. A representative computing system comprises a processing system and communication transceiver. A representative computing system may also include other components such as a router, server, data storage system, and power supply. The computing system could reside in a single device or may be distributed across multiple devices and may be a discrete system or could be integrated within other systems, including other systems within communication network 100. Some examples of representative computing systems include desktop computers, server computers, cloud computing platforms, and virtual machines, as well as any other type of computing system, variation, or combination thereof. In some examples, the computing system could comprise a web server, CDN, reverse proxy, load balancer, middleware, cloud server, network switch, router, switching system, packet gateway, network gateway system, Internet access node, application server, database system, service node, firewall, or some other communication system, including combinations thereof.

Web resources 130 may be provided by any computing apparatus, system, or systems that may connect to another computing system over a communication network. Web resources 130 may be provided by systems that could comprise a data storage system and communication transceiver. Web resources 130 may be provided by systems that could also include other components such as a processing system, router, server, and power supply. Web resources 130 may reside in a single device or may be distributed across multiple devices. Web resources 130 may be provided by a discrete system or may be provided by multiple systems, including other systems within communication network 100. Some examples of systems that may provide web resources 130 include database systems, desktop computers, server computers, cloud computing platforms, and virtual machines, as well as any other type of computing system, variation, or combination thereof. In some examples, web resources 130 could be provided by a web server, CDN, reverse proxy, load balancer, middleware, cloud server, network security appliance, firewall, intrusion prevention system, network switch, router, switching system, packet gateway, network gateway system, Internet access node, application server, database system, service node, or some other communication system, including combinations thereof. In some implementations, web resources 130 could comprise any resources used in the provision of a web application, such as scripts, code libraries, fonts, JavaScript files, images, and any other web application components, which may be stored on a database or some other data storage system that provides web resources 130 for a web application.

In at least one implementation, web resources 130 could be part of an origin web server that provides a web application, which may include internal inline scripts that are embedded into hypertext markup language (HTML) pages, but web resources 130 could also represent first party web resources of the web application owner that are provided via CDNs and other external data sources. Additionally, or alternatively, web resources 130 could also represent external web resources that are provided by third parties, such as advertisers or external libraries, which would also be served by external data sources.

Security server 140 is representative of one or more computing devices configured to provide monitor user data privacy in web applications hosted by web server 110. Security server 140 may comprise a server, a cloud computing system, or any other computing system, network equipment, apparatus, system, or systems that may connect to another computing system over a communication network. Security server 140 may comprise a system that provides a cloud-based web service. Security server 140 comprises a processing system and communication transceiver. Security server 140 may also include other components such as a router, server, data storage system, and power supply. Security server 140 may reside in a single device or may be distributed across multiple devices. Security server 140 may be a discrete system or may be integrated within other systems, including other systems within communication network 100. Some examples of security server 140 includes database systems, desktop computers, server computers, cloud computing platforms, and virtual machines, as well as any other type of computing system, variation, or combination thereof.

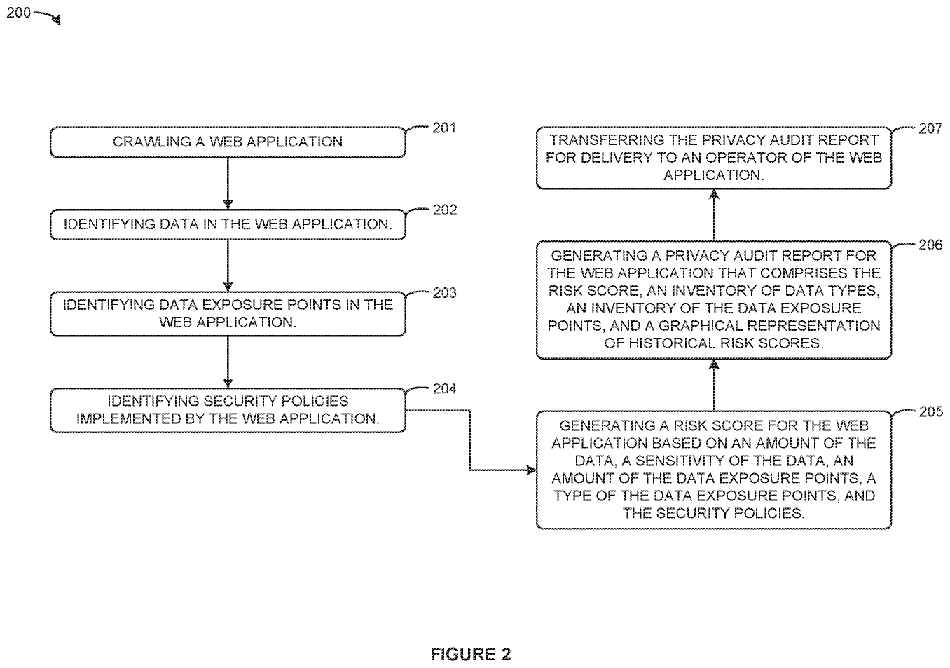

In some examples, security server 140 is configured to implement process 200 described in FIG. 2. Security server 140 may configured to execute software modules 142-144 to generate privacy audit reports for web applications delivered to web browser 120 from web server 110. Data extraction module 142 is configured to scan the web applications and identify all user data, points of data exposure, user data sensitivity, and security protocols on the web application. Risk assessment module 143 is configured to score the privacy risk for the web application based on the scan and generate a privacy audit report that characterizes the privacy risk for user data on the website. Exposure module 144 is configured to transfer privacy audit reports for delivery to human operators of web server 110 to surface the privacy risk for web applications.

Communication system 150 could comprise multiple network elements such as routers, gateways, telecommunication switches, servers, processing systems, or other communication equipment and systems for providing communication and data services. In some examples, communication system 150 could comprise wireless communication nodes, telephony switches, Internet routers, network gateways, computer systems, communication links, or some other type of communication equipment, including combinations thereof. Communication system 150 may also comprise optical networks, packet networks, local area networks (LAN), metropolitan area networks (MAN), wide area networks (WAN), or other network topologies, equipment, or systems, including combinations thereof. Communication system 150 may be configured to communicate over wired or wireless communication links. Communication system 150 may be configured to use Internet Protocol (IP), Ethernet, optical networking, wireless protocols, communication signaling, or some other communication format, including combinations thereof. In some examples, communication system 150 includes further access nodes and associated equipment for providing communication services to several computer systems across a large geographic region.

Web server 110, web browser 120, web resources 130, security server 140, and communication system 150 comprise microprocessors, software, memories, transceivers, bus circuitry, and the like. The microprocessors comprise Central Processing Units (CPU), Graphical Processing Units (GPU), Application-Specific Integrated Circuits (ASIC), Field Programmable Gate Array (FPGA), and/or types of processing circuitry. The memories comprise Random Access Memory (RAM), flash circuitry, disk drives, and/or the like. The memories store software like operating systems, security modules, user applications, web applications, and browser applications. The microprocessors retrieve the software from the memories and execute the software to drive the operation of communication network 100 as described herein. Communication links 151-154 that connect the elements of communication network 100 use metallic links, glass fibers, radio channels, or some other communication media. The communication links use ENET, Time Division Multiplex (TDM), Data Over Cable System Interface Specification (DOCSIS), Internet Protocol (IP), General Packet Radio Service Transfer Protocol (GTP), Institute of Electrical and Electron Engineers (IEEE) 802.11 (WIFI), IEEE 802.3 (ENET), virtual switching, inter-processor communication, bus interfaces, and/or some other data communication protocols. Web server 110, web browser 120, web resources 130, security server 140, and communication system 150 may exist as unified computing devices or may be distributed between multiple computing devices.

In some examples, communication network 100 implements process 200 illustrated in FIG. 2. It should be appreciated that the structure and operation of communication network 100 may differ in other examples.

FIG. 2 illustrates process 200. Process 200 comprises an automated process to generate a privacy audit report for a web application. Process 200 may be implemented in program instructions in the context of any of the software applications, module components, or other such elements of one or more computing devices. The program instructions direct the computing devices(s) to operate as follows, referred to in the singular for the sake of clarity.

The operations of process 200 include crawling a web application (step 201). The operations continue by identifying data in the web application (step 202). The operations continue by identifying data exposure points in the web application (step 203). The operations continue by identifying security policies implemented by the web application (step 204). The operations continues by generating a risk score for the web application based on an amount of the data, a sensitivity of the data, an amount of the data exposure points, a type of the data exposure points, and the security policies (step 205). The operations continues by generating a privacy audit report for that web application that comprises the risk score, an inventory of data types, an inventory of the data exposure points, and a graphical representation of historical risk scores (step 206). The operations continue with transferring the privacy audit report for delivery to an operator of the web application (step 207).

Referring back to FIG. 1, communication network 100 includes a brief example of process 200 as employed by one or more applications hosted by security server 140. The operation may differ in other examples.

In operation, security server 140 executes data extraction module 142. Data extraction module 142 crawls a web application hosted by web server 110 to identify all data, data exposure points, and security policies used on the web site (step 201). For example, extraction module 142 may download a web application. Extraction module 142 discovers the presence or lack of privacy policy on the site, discovers of all the scripts present on the site, discovers all the third-party integrations on a web application, and discovers all potentially sensitive data (steps 202-203). Extraction module 142 maps all the sensitive data that is exposed to third party vendors. For example, extraction module 142 may identify user data present on the web application and third-party JavaScripts that execute on the user data. Extraction module 142 maps the method of exposure (data exposed via forms, cookies, storage, in memory) and the level of exposure (data is read, accessed, and sent to) of all sensitive data. For example, extraction module 142 may categorize the user data to identify sensitive data like social security numbers and credit card numbers and map the sensitive data to scripts that have access to the sensitive data. Extraction module 142 may utilize vendor data-flow mapping on to determine what data is exposed, read, and leaked to which vendors.

Extraction module 142 may categorize data on all cookies, forms, and storage elements on the web application. Exposure module 142 may identify all the cookies both first- and third-party cookies on a site. If sensitive data is present in cookies, extraction module 142 may determine additional attributes for the cookies like the expiration date, whether the cookies are persistent or session based, HTTPS only and the cross-site restriction policy is accounted for.

In conjunction with the discovery of sensitive data and the mechanism of exposure, extraction module 142 determines what security polies are available to the web application hosted by web server 110. The web application may employ standard security controls like Content Security Policy (CSP), Sub-resource Integrity (SRI), permissions policy, and the like. The security policies allow web server 110 and web browser 120 to govern the allowable behaviors on the web application. For example, web server 110 may utilize CSP to sandbox scripts from a particular vendor and disable access to Application Programming Interfaces (APIs). Additional security controls like Permissions Policy, HTTP Strict Transport Security (HSTS), Cross-Origin Resource Sharing (CORS) headers, and the like provide additional guardrails into acceptable behaviors on the site. Extraction module 142 determines what security policies are available to the web application and which of the security policies are implemented by the web application.

Security server 140 executes risk assessment module 143 to calculate a risk score for the web application based on the information extracted from the web application by extraction module 142 (step 205). The risk score comprises a metric that characterizes the overall security vulnerability of user data present on, or available to, the web application. Risk assessment module 143 generates the risk score based on the amount of data on the web application, the amount and type of exposure points for the data (e.g., number of scripts that have access to the data), the sensitivity of the data, and the security policies implemented by the web application. For example, risk assessment module 143 may utilize a weighted function algorithm that intakes the amount of data, the amount of exposure points, the type of exposure, the data sensitivity, and the security policies as inputs and outputs a risk score for the web application.

Generally, as the amount of data increases, the risk score increases. As the amount of data exposure points increases, the risk score increase. As the proportion of exposure points that comprise third-party exposure points increases, the risk score increases. As the sensitivity of the data increases, the risk score increases. For example, the risk score for social security information may be higher than home addresses. As the amount of security policies implemented by the website decreases, the risk score increases. For example, a web application that utilizes CSP may have a lower risk score than a website that utilizes no security protocols. Likewise, the inverse for any of the aforementioned risk score factors alters the risk score accordingly (e.g., a decrease in the amount of data decreases the risk score).

Upon calculating the risk score, risk assessment module 143 generates a privacy audit report to characterize the privacy risk of user data associated with the web application (step 206). The privacy audit report comprises a set of graphical and textual information to illustrate the privacy risk score. For example, the privacy audit report may comprise the calculated risk score for the web application, historical risk scores to illustrate how the risk scores have changed over time, inventories for all of the data on the website, and inventories for data exposure points on the website. The privacy audit report may comprise text, graphs, pie charts, drop down menus, user selectable options, and/or other types of information to characterize the privacy risk for the data. The privacy audit report may be configured for display on a display screen of a computing device.

Security server 140 executes exposure module 144 to relay the privacy audit report to human operators of web server 110. Exposure module 144 transfers the privacy audit report for delivery to an operator of web server 110 (step 207). For example, exposure module 144 may send an email to a personal computing device of an operator. The email may comprise a hyperlink that, upon selection by an operator, causes the personal computing device to download the privacy audit report from a remote storage system and present the privacy audit report to the operator.

Advantageously, security server 140 effectively determines the data exposure risk for user data on web applications. Moreover, security server 140 generates privacy audit reports that contextualize the privacy risk of the user data.

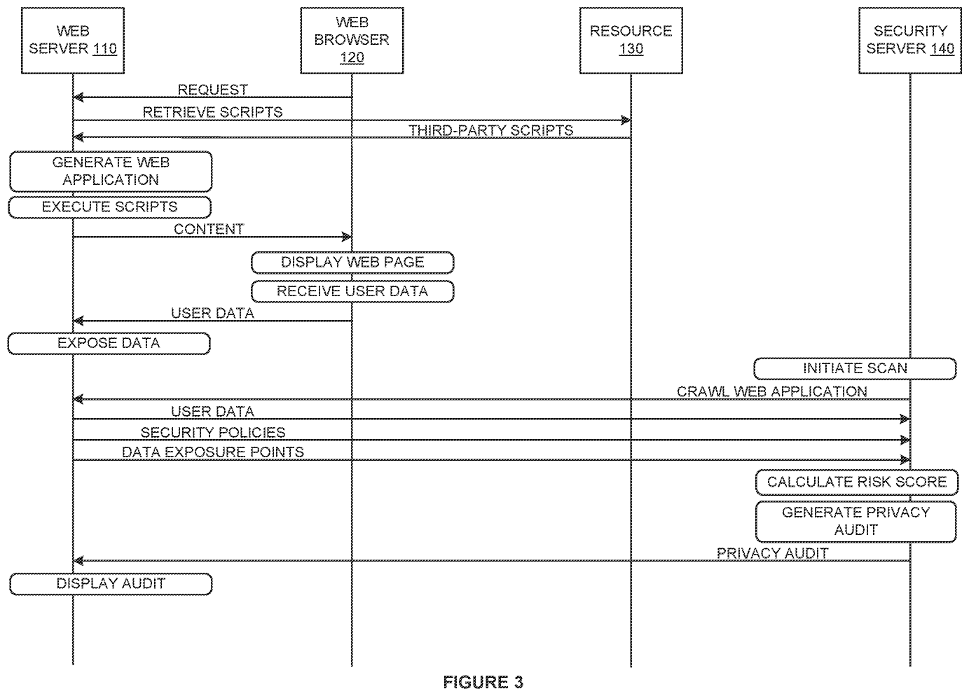

FIG. 3 illustrates an exemplary operation of communication network 100 to generate privacy audit reports. The exemplary operation depicted in FIG. 3 is an example of process 200 illustrated in FIG. 2, however process 200 may differ. In other examples, the structure an operation of communication network 100 may differ.

In operation, a user operates a computing system to execute web browser 120 to access a web application, such as a website provided by web server 110. Web browser 120 submit page requests to web server 110 to access the various pages that comprise the web application. Web server 110 accesses web resources 130 from many different third-party service providers, including CDNs and third-party libraries to render the web application. In response to the page requests, web server 110 specifies a security policy in a CSP response header that lists all of the trusted sources that host web resources 130, such as the domain names or URLs of the valid third-party hosts from which the web browser 120 can download legitimate JavaScript files, fonts, images, embeddable objects, and other web content. As part of this process, the web browser 120 may analyze the CSP response header and verify that the web application is behaving according to the security policy specified in the CSP header, meaning that the web application is only accessing web resources 130 from the valid origins listed in the policy.

Web browser 120 downloads the web application from web server 110 and displays the web application. Web browser 120 may display the web application on a display screen of the user computing device that hosts browser 120. A user interacts with user interface systems of the computing device to input user data into the web application. For example, the user interface systems may receive user generated keystroke inputs. Web browser 120 detects the user inputs and supplies corresponding user data into the web application. The user data may comprise information like names, addresses, ages, social security numbers, credit card numbers, banking information like routing numbers, and/or other types of user data. Web server 110 receives the user data input into the web application via web browser 120. Upon reception of the user data, web server 110 exposes the received user data to first- and third-party scripts. For example, web server 110 may utilize a third-party JavaScript to manipulate the received user data thereby exposing (or potentially exposing) the user data to third party sources.

Security server 140 initiates a privacy scan for the web application hosted by web server 110. For example, the operator of web server 110 may have scheduled privacy scans for the hosted web application and security server 140 may initiate the scan in response to the schedule. Data extraction module 142 crawls the web application to categorize the user data, the scripts and other resources that have access to the user data, and the security policies used by web server 110. Web server 110 indicates the user data, security policies, and the data exposure points to extraction module 142. Data extraction module 142 categorizes the data exposure points to determine the total amount of first-party JavaScripts and third-party JavaScripts used on the web application. Data extraction module 142 determines the proportion of the scripts that comprise third-party scripts and the proportion of the scripts that comprise first-party scripts. Data extraction module 142 determine the total amount of user data on the web application and categorizes the user data by sensitivity. Data extraction module 142 categorizes the security policies available to the web application to determine what policies are in use.

Risk assessment module 143 calculates a risk score for the web application based on the discovery and categorization procedure implemented by data extraction module 142. The score is affected by the amount of data, the sensitivity of the data, the number of scripts used on the web application, and the security policies used on the web application. The score may be generated based on two primary categories of relevance that comprise security controls effectiveness and data sensitivity analysis. Risk assessment module 143 ranks the effectiveness the security controls. For example, risk assessment module 143 may rate the strength of the following controls to be weak or strong on a sliding scale: CSP, SRI, HSTS, X-content type-options, permissions policy, referrer policy, X-frame options, and Cross Site Scripting (XSS) protection.

Risk assessment module 143 performs data sensitivity analysis to determine what data is exposed and the sensitivity of the exposed data. Risk assessment module 143 may determine how the user data is collected how the user data is shared internally and externally. For example, risk assessment module 143 may determine forms and cookies on the web application that intake user data. Risk assessment module 143 may determine how the web application stores the received user data. For example, risk assessment module 143 may determine if the web application stores user data as a hard copy, digital copy, in a database, bring your own device storage, mobile phone storage, and the like. Risk assessment module 143 analyzes vendors for the third-party scripts and based on vendor reputation. For example, risk assessment module 143 may perform data flow mapping for the user data and an allowed list of vendors and determine changes to the data flow over time. Risk assessment module 143 performs data flow analysis on the user data to determine network locations the data traverses. For example, risk assessment module may determine if the user data is held locally, is sent to a cloud service, is sent to a third parties, and the like. Risk assessment module 143 may further determine entities in web server 110 that are accountable for the user data, how often the user data is transferred, entities that have access to the user data, and determine the lawful basis used for processing the user data.

Risk assessment module 143 generates a privacy audit report that lists out the risk score and a summary of the findings and areas that need attention. The privacy audit report also provides further information for user data inventory, data flow analysis, vendor reputation, and the like. For example, the privacy audit report may include Uniform Resource Locators (URL) for third-party JavaScript vendors. Exposure module 144 transfers the privacy audit report for delivery to operators of web server 110. This enables privacy, compliance, and application security teams to implement policies that will directly impact their privacy assurance robustness.

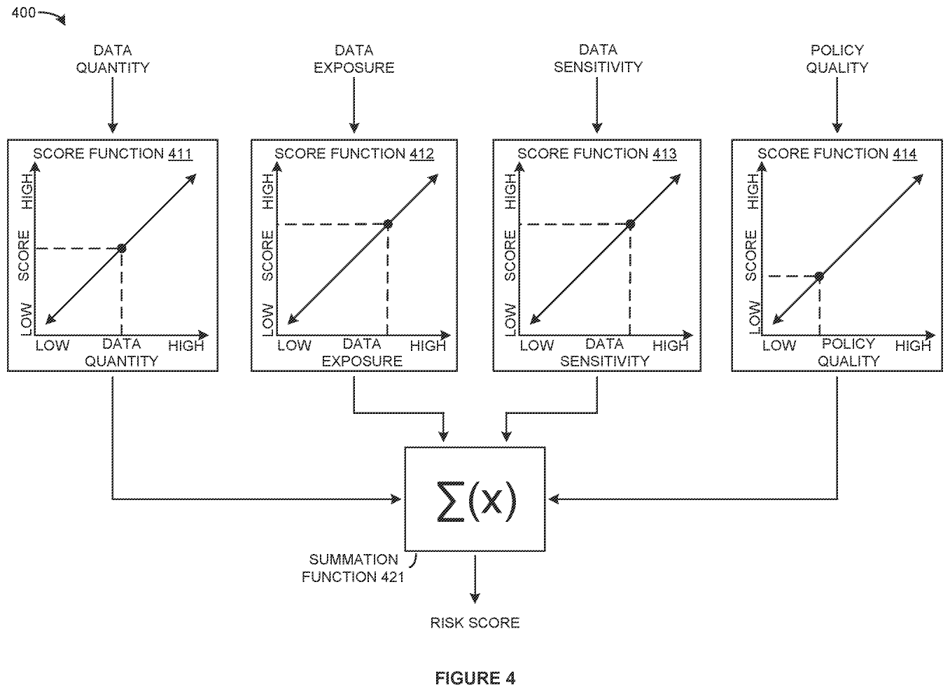

FIG. 4 illustrates block diagram 400 to generate privacy audit reports for a web application. Block diagram 400 comprises an example of process 200, and the exemplary operation depicted in FIG. 3, however process 200 and the exemplary operation depicted in FIG. 3 may differ. Block diagram 400 comprises score functions 411-414, and summation function 421. Score functions 411-414 comprise data structures that intake factors like data quantity, data exposure, data sensitivity, and policy quality as inputs and output risk scores based on the inputs. Summation function 421 combines the scores output by functions 411-414 to generate a privacy risk score for a web application. For example, summation function 421 may comprise a weighted sum function.

Score function 411 comprises a graph that correlates data quantity to a privacy risk score. The x-axis of score function 411 comprises data quantity in an exemplary range of low to high. The y-axis of score function 411 comprises a risk score in an exemplary range of low to high. As illustrated in FIG. 4, a data quantity in a web application correlates to a risk score. Score function 412 comprises a graph that correlates data exposure to a privacy risk score. The x-axis of score function 412 comprises data exposure in an exemplary range of low to high. The y-axis of score function 412 comprises a risk score in an exemplary range of low to high. As illustrated in FIG. 4, a data quantity in a web application correlates to a risk score. Score function 413 comprises a graph that correlates data exposure to a privacy risk score. The x-axis of score function 413 comprises data sensitivity in an exemplary range of low to high. The y-axis of score function 413 comprises a risk score in an exemplary range of low to high. As illustrated in FIG. 4, a data sensitivity in a web application correlates to a risk score. Score function 414 comprises a graph that correlates security policy quality to a privacy risk score. The x-axis of score function 414 comprises security policy quality in an exemplary range of low to high. The y-axis of score function 414 comprises a risk score in an exemplary range of low to high. As illustrated in FIG. 4, a security policy quality in a web application correlates to a risk score.

In some examples, summation function 421 utilizes a weighted summation function to combine the risk scores output by score functions 411-413. For example, summation function 421 may implement a function with the following form:

$${Risk}_{Privacy} = {Risk}_{Exposure} ( 1 - F \times \frac{{Risk}_{Controls}}{100} ) \qquad ( 1 )$$

where Risk_{Privacy} E [0,100] and represents the overall privacy risk score with scores 0 and 100 representing the lowest and highest risk levels, respectively. Risk_{Exposure} [0,100] and represents the risk score associated with the data exposure factor (e.g., the risk score output by score function 411-412). Risk_{Controls} E [0,100] and represents the risk score associated with the data exposure factor (e.g., the risk score output by score function 413). F comprises a fraction bounded by the range [0, 1] that represents the maximum possible risk reduction percentage. For example, when F=0.2 there is a 20% reduction in the exposure when optimal security controls are in place (i.e., Risk_{Controls}=0). For this case, the privacy risk score changes between 80% and 100% of the Risk_{Exposure} value where:

Risk_{Privacy}∈[0.8Risk_{Exposure},Risk_{Exposure}]

where the lowest privacy risk score, representing 80% of the data exposure risk (i.e., 20% reduction), correspond to the best-case security controls, (i.e., Risk_{Controls}=100). The highest privacy risk score, representing the 100% of the data exposure risk, corresponds to the worst-case security controls (i.e., Risk_{Controls}=0).

At a high level, summation function 421 relies on two independent factors while measuring the privacy risk of the data used in a web application. The first of these factors comprises data exposure represented by Risk_{Exposure} in equation (1) and the second factor comprises security controls represented by Risk_{Controls} in equation (1).

The Risk_{Exposure} factor depends on the amount of data, the sensitivity of the data, and the access to the data. Generally, as the amount of data increases, the risk of data exposure increases. Score function 411 receives a data quality indication and correlates the amount of data to a data quantity risk score. Summation function 421 uses the data quantity risk score, in part, to determine Risk_{Exposure}.

Generally, as the amount of data access increases, the risk of data exposure increases. Score function 412 receives a data access indication and correlates the amount of data exposure to a data exposure risk score. Summation function 421 uses the data exposure risk score, in part, to determine Risk_{Exposure}. In the context of a web application, data may be accessed through a JavaScript code belonging to a first- or a third-party vendor. Data exposure risk factors for measuring the risk include the party of the script, the amount of access, and the evidence of access. Data accessed by a third party is considered to have a higher risk than that of the first party. Note that the first party access also may comprise inherent risk as well because a first party script can be compromised via a vulnerability exploit or a malware infection. Score function 412 may determine the party of scripts and generate raw risk score Risk_{Party}(P), where P represents the first or a third party. For example, score function 412 may generate the party specific raw risk score where Risk_{Party}(First)=1 and Risk_{Party}(Third)=2. In other examples different values may be used. Score function 412 determines the amount of access as well to generate the data exposure risk score. As the number scripts that have access to the data, higher is the risk.

Score function 412 further determines evidence of access to generate the data exposure risk score. Score function 412 may determine observed runtime behavior using dataflow analysis of JavaScript code to determine if the script is accessing the data, if the script is not accessing the data but it can still run on the web page where the data is present, or if the script is not present on the web page and cannot access the data. Score function 412 may compute a raw risk score defined as Risk_{Access}(A), where A can have values Sure, Possible, or None covering the above-mentioned possibilities. For example, score function 412 may generate the party specific raw risk score where Risk_{Access}(Sure)=2, Risk_{Access}(Possible)=1, and Risk_{Access}(None)=0. The value of Risk_{Access}(None) should be always set to 0 because there is no risk of any exposure.

Generally, as the sensitivity of the data increases, the consequences of data exposure increases. Score function 413 receives a data sensitivity indication and correlates the indication to a data sensitivity score. Summation function 421 uses the data sensitivity risk score, in part, to determine Risk_{Exposure}. In some examples, score function 413 categorizes the sensitivity level of the data into three categories. For example, score function 413 categorizes data as low sensitivity (e.g., person name), medium sensitivity (e.g., home address), or high sensitivity (e.g., social security number). Score function 413 may output a raw risk score defined as Risk_{Sensitivity} (C) associated with the category C. To capture the differences in the risk levels, the values are tuned such as Risk_{Sensitivity}(Low)<Risk_{Sensitivity}(Medium)<Risk_{Sensitivity}(High). For example, C may be set to Risk_{Sensitivity}(LOW)=¹, Risk_{Sensitivity}(Medium)=2, and Risk_{Sensitivity}(High)=4. However, the corresponding risk values for C may differ in other examples.

Generally, as the quality of security controls implemented by a web application decreases, the consequences of data exposure increases. Score function 414 receives a security policy indication and correlates the quality of the security policy to a security controls risk score. Summation function 421 uses the security controls risk score to determine Risk_{Controls}. The security of the data directly affects its privacy risk. The more secure the data is, the less is the privacy leakage risk. Score function 414 considers the security measures that are implemented using standards-based browser control techniques. The security measures comprise security policies that are enforced by the browser on the client side. The policies are delivered to the browser in the form of either HTTP headers (e.g., CSP, HSTS, referrer policy, etc.), or HTML, tags (e.g., iframe sandboxing). For measuring the impact of such a policy over privacy, score function 414 determines if the policy is applied. When the security policies are applied by the browser, the privacy risk is lower. Score function 414 determines the quality of the policy: For example, if a CSP is too permissive, it becomes less secure, thereby increasing the privacy risk of the data.

Summation function 421 computes Risk_{Exposure} based on the score outputs generated by score functions 411-413. In some examples, Risk_{Exposure} may be defined as:

$${Risk}_{Exposure} = 100 \times min ( \frac{D}{M} , 1 )$$

where D represents a raw risk score associated with the privacy sensitive data accesses. D may be computed as a sum over the risk score associated with individual data access as:

$$D = {\sum }_{i = 1}^{N} {Risk}_{Data} ( {d}_{i} )$$

where N represents the total number of privacy sensitive data items, and the variable dᵢ represents the i^{th} data item. The function Risk_{Data}(d) captures the raw risk score associated with the access to the data item d. Note that D can be an arbitrarily high value greater than zero, but it is proportionate to the number of data items. Hence, to create a bounded value for Risk_{Exposure}, a normalizing constant M is defined as the threshold that captures the maximum risk score value for Risk_{Exposure}. In other words, if D<M, then Risk_{Exposure}<100, else Risk_{Exposure}=100.

Risk_{Data}(d) can be defined for raw risk score associated with the individual data accesses as:

$${Risk}_{Data} ( d ) = {Risk}_{Sensitivity} ( Sensitivity ( d ) ) \times {\sum }_{i = 1}^{S} {Risk}_{script} ( {js}_{i} , d )$$

where the function Sensitivity(d) returns the sensitivity category (i.e., Low, Medium, High) of the data item d. The number S represents the total number of JavaScripts discovered. The function Risk_{Script}(js, d) represents the raw score associated with the access of the data item d by the JavaScript js. Risk_{Script}(js, d) may be defined as:

Risk_{Script}(js,d)=Risk_{Party}(ScriptParty(js))×Risk_{Access}(ScriptAccess(js,d))

where the function ScriptParty(js) returns the party (i.e., first-party, or third-party) associated with the JavaScript js. The function ScriptAccess(js, d) returns the type of access (i.e., None, Possible, or Sure) the JavaScript js has with respect to the data item d. It should be appreciated that if the JavaScript js cannot access the data item d, the score would automatically be zero.

Summation function 421 computes Risk_{Controls} based on the score output generated by score functions 414. In some examples, Risk_{Controls} may be defined as:

$${Risk}_{Controls} = {\sum }_{i = 1}^{K} {W}_{Policy} ( {policy}_{i} ) \times {Risk}_{Policy} ( {policy}_{i} )$$

where Risk_{Policy}(p) E [0,100] and represents the privacy risk score as an effect of applying the browser control policy p. The weights W_{Policy}(policyᵢ)∈[0,1] are chosen to capture the relative importance of different types of security policies. The value K represents the number of different types of applicable policies in the web application.

The function Risk_{Policy}(p) may be defined as:

Risk_{Policy}(p)=100−PolicyApplied(p)×PolicyQuality(p)

where the function PolicyApplied(p)=1 when the browser control policy p is applied and =0 when the browser control policy p is not applied. The function PolicyQuality(p) returns a value in [0, 100], that represents the quality or the effectiveness of a specific discovered configuration of the policy p. Thus, values 0 and 100 represent the lowest and the highest quality levels, respectively. Note that the policy related risk score is inversely proportional to the quality. As the quality increases, the risk score decreases, and vice versa. Policy quality may be assessed using online system for measuring the quality of policy configurations (e.g., csper.io, securityheaders.io, https://csp-evaluator.withgoogle.com). Summation function 421 outputs the total risk score for a web application. Downstream systems may utilize the risk score to generate privacy audit reports.

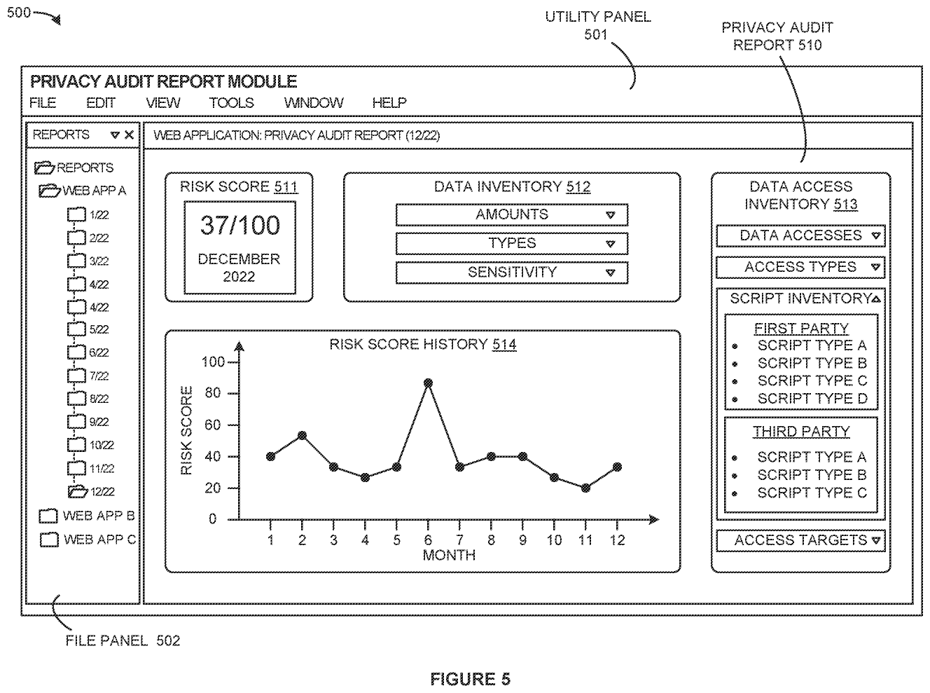

FIG. 5 illustrates user interface 500 to present a privacy audit report according to some embodiment of the present technology. For example, communication network may implement process 200 to generate user interface 500 illustrated in FIG. 5. In other examples, user interface 500 may differ. User interface 500 may be displayed on a user interface device like a user computer, tablet computer, smartphone, and the like. User interface 500 comprises a GUI configured to allow a user to view a privacy audit report for a web application. The GUI provides visualizations for risk scores, data inventories, data exposure inventories, and risk score history. In other examples, the GUI of user interface 500 may differ.

User interface 500 includes utility panel 501. Utility panel 501 comprises tabs like file, edit, view, tools, window, and help that allow a user to navigate user interface 500. The tabs may comprise user selectable drop-down menus that, upon selection, open to reveal additional functionality. For example, a user may select the file tab to view the additional functionality. In other examples, utility panel 501 may comprise differ tabs. User interface further includes file panel 502. File panel 502 comprises a hierarchical electronic file system that allows users to select and import privacy audit reports into user interface 500. In this example, a user has selected the file labeled “WEB APP A” and opened the file for privacy audit report 510.

User interface 500 includes privacy audit report 510. For example, user interface 500 may present a selectable option that, in response to user action, drives user interface 500 to display privacy audit report 510. In some examples, the computing device displaying user interface 500 may receive a hyperlink that links to privacy audit report 500. User interface 500 may present the hyperlink on the display system of the computing device. A user may select the hyperlink which drives the computing device to download privacy audit report 510 and display report 510 on interface 500 for review by a user.

Privacy audit report 510 comprises risk score 511, data inventory 512, data access inventory 513, and risk score history 514. Risk score 511 comprises a privacy risk score for user data associated with a web application. For example, risk score 511 may be generated by a computing device implementing block diagram 400 illustrated in FIG. 4. In this example, risk score 511 comprises the value 37/100 for the month of December in the year 2022. In other examples, the score and time period for the score may differ. Risk score 511 indicates the exposure risk for user data on a web application.

Privacy audit report 510 comprises data inventory 512. Data inventory 512 comprises user selectable drop-down tabs labeled amounts, types, and sensitivity to categorize the user data on the web application by amount, type, and sensitivity. For example, a user may select the drop-down tab labeled sensitivity to view sensitivity levels for data items on the web application.

Privacy audit report 510 comprises data access inventory 513. Data access inventory 513 comprises user selectable drop-down tabs labeled data accesses, access types, script inventory, and access targets to categorize how the user data on the web application is accessed. The drop-down tab for data accesses comprises information that indicates how user data on the web application is accessed. The drop-down tab for access types comprises information that characterizes the detected data accesses. For example, the characterization may indicate a third-party script accessed user data in the web application. The script inventory tab comprises information that characterizes the scripts used on the web application as either first-party or third-party and further categorizes the scripts by type. The drop-down tab for access targets comprises information that indicates what user data items were accessed. In this example, a user selected the script inventory tab, however in other examples, a user may select a different one of the drop-down tabs in inventory 512 and/or inventory 513.

Privacy audit report comprises risk score history 514. Risk score history 514 comprises a graph that illustrates how risk scores have changed over time. The x-axis of the graph comprises months in the exemplary range 1-12. The y-axis of the graph comprises risk score in the exemplary range 0-100. The graph plots risk scores for a web application over a period of 12 months. In other examples, the time period may differ. For example, the graph may plot quarterly risk scores. In other example, privacy audit report 510 may comprise additional or different visuals to describe the privacy risk for user data on a web application.

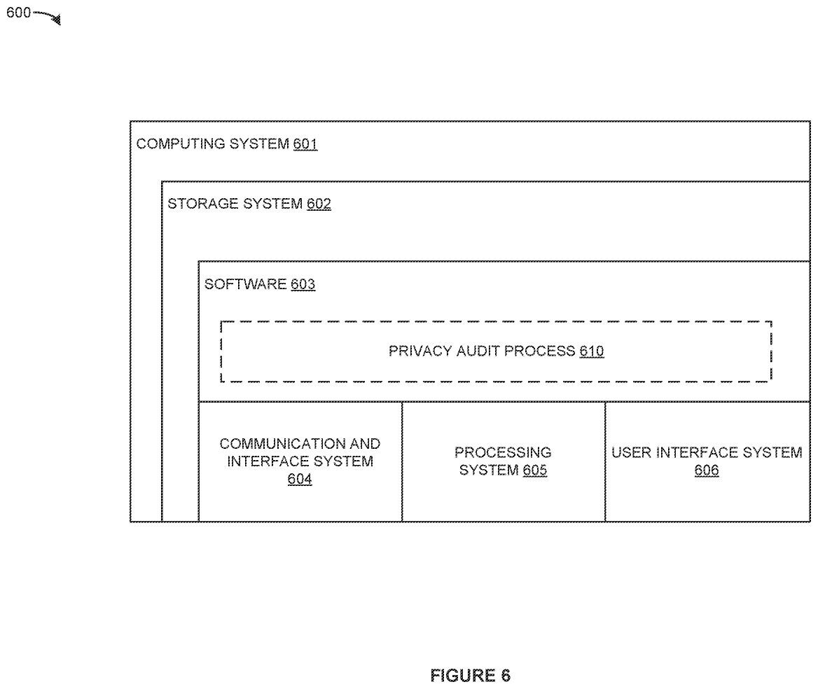

FIG. 6 illustrates computing device 601 which is representative of any system or collection of systems in which the various processes, programs, services, and scenarios disclosed herein for generating privacy audit reports for web applications may be implemented. For example, computing device 601 may be representative of web server 110, web browser 120, web resources 130, security server 140, and/or communication system 150. Examples of computing system 601 include, but are not limited to, server computers, routers, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 includes, but is not limited to, storage system 602, software 603, communication and interface system 604, processing system 605, and user interface system 606. Processing system 605 is operatively coupled with storage system 602, communication interface system 604, and user interface system 606.

Processing system 605 loads and executes software 603 from storage system 602. Software 603 includes and implements privacy audit process 610, which is representative of the processes to scan web applications and generate privacy audit reports discussed with respect to the preceding Figures. For example, privacy audit process 610 may be representative of process 200 illustrated in FIG. 2, the exemplary operation of communication network 100 illustrated in FIG. 3, and/or block diagram 400 illustrated in FIG. 4. When executed by processing system 605, software 603 directs processing system 605 to operate as described herein for at least the various processes, operational scenarios, and sequences discussed in the foregoing implementations. Computing system 601 may optionally include additional devices, features, or functionality not discussed here for purposes of brevity.

Processing system 605 may comprise a micro-processor and other circuitry that retrieves and executes software 603 from storage system 602. Processing system 605 may be implemented within a single processing device but may also be distributed across multiple processing devices or sub-systems that cooperate in executing program instructions. Examples of processing system 605 include general purpose central processing units, graphical processing units, application specific processors, and logic devices, as well as any other type of processing device, combinations, or variations thereof.

Storage system 602 may comprise any computer readable storage media that is readable by processing system 605 and capable of storing software 603. Storage system 602 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 602 may also include computer readable communication media over which at least some of software 603 may be communicated internally or externally. Storage system 602 may be implemented as a single storage device but may also be implemented across multiple storage devices or sub-systems co-located or distributed relative to each other. Storage system 602 may comprise additional elements, such as a controller, capable of communicating with processing system 605 or possibly other systems.

Software 603 (privacy audit process 610) may be implemented in program instructions and among other functions may, when executed by processing system 605, direct processing system 605 to operate as described with respect to the various operational scenarios, sequences, and processes illustrated herein. For example, software 603 may include program instructions for scanning a web application, scoring the web application, and generating a privacy risk audit as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 603 may include additional processes, programs, or components, such as operating system software, virtualization software, or other application software. Software 603 may also comprise firmware or some other form of machine-readable processing instructions executable by processing system 605.

In general, software 603 may, when loaded into processing system 605 and executed, transform a suitable apparatus, system, or device (of which computing system 601 is representative) overall from a general-purpose computing system into a special-purpose computing system customized to generate privacy audit reports described herein. Indeed, encoding software 603 on storage system 602 may transform the physical structure of storage system 602. The specific transformation of the physical structure may depend on various factors in different implementations of this description. Examples of such factors may include, but are not limited to, the technology used to implement the storage media of storage system 602 and whether the computer-storage media are characterized as primary or secondary storage, as well as other factors.

For example, if the computer readable storage media are implemented as semiconductor-based memory, software 603 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 604 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of computing devices configured to generate privacy audit reports for web applications, it should be understood that the systems and methods described herein are not limited to such embodiments and may apply to a variety of other extension implementation environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A system to generate a privacy audit report for a web application, the system comprising:
a memory that stores executable components; and
a processor, operatively coupled to the memory, that executes the executable components, the executable components comprising:
a data extraction component configured to crawl the web application, identify data in the web application, identify data exposure points in the web application, and identify security policies implemented by the web application;
a risk assessment component configured to generate a risk score for the web application based on an amount of the data, a sensitivity of the data, an amount of the data exposure points, a type of the data exposure points, and the security policies;
the risk assessment component configured to generate the privacy audit report for the web application that comprises the risk score, an inventory of data types, an inventory of the data exposure points, and a graphical representation of historical risk scores; and
an exposure component configured to transfer the privacy audit report for delivery to an operator of the web application.

2. The system of claim 1 wherein:
the data extraction component is configured to identify data exposure points in the web application comprises the data extraction component configured to identify first-party scrips that access the data in the web application and identify third-party scrips that access the data in the web application; and
the risk assessment component is configured to generate the risk score for the web application based on the amount of the data exposure points comprises the risk assessment component configured to generate the risk score based on a total amount of the first-party scrips and the third-party scrips that have access to the data.

3. The system of claim 1 wherein:
the data extraction component is configured to identify data exposure points in the web application comprises the data extraction component configured to identify first-party scrips that access the data in the web application and identify third-party scrips that access the data in the web application; and
the risk assessment component is configured to generate the risk score for the web application based on the type of the data exposure points comprises the risk assessment component configured to generate the risk score based on an amount of the first-party scripts and an amount of the third-party scripts.

4. The system of claim 1 wherein:
the data extraction component is configured to identify data exposure points in the web application comprises the data extraction component configured to identify first-party scrips that access the data in the web application and identify third-party scrips that access the data in the web application; and wherein:
the risk assessment component is configured to generate the risk score for the web application further comprises the risk assessment component configured to determine evidence of data access for the first-party scripts and evidence of data access for the third-party scripts based on data flow analysis, a co-presence of the data and the first-party scripts on the web application, and a co-presence of the data and the third-party scripts on the web application and generate the risk score based on the evidence of data access.

5. The system of claim 1 wherein:
the risk assessment component is configured to generate the risk score for the web application based on the sensitivity of the data comprises the risk assessment component configured to determine the types for the data, generate a sensitivity score for the data based on the data types, and generate the risk score based on the sensitivity score.

6. The system of claim 1 wherein:
the risk assessment component is configured to generate the risk score for the web application based on the security policies comprises the risk assessment component configured to determine which of the security policies are applied by the web application, determine a quality of the security policies, and generate the risk score based on which of the security policies are applied and the quality of the security policies.

7. The system of claim 1 wherein:
the risk assessment component is configured to generate the risk score for the web application based on the amount of the data, the sensitivity of the data, the amount of the data exposure points, the type of the data exposure points, and the security policies comprises the risk assessment component is configured to execute a weighted sum function to generate the risk score.

8. A method to generate a privacy audit report for a web application, the method comprising:
crawling, by a system comprising a processor, the web application, identifying data in the web application, identifying data exposure points in the web application, and identifying security policies implemented by the web application;
generating, by the system, a risk score for the web application based on an amount of the data, a sensitivity of the data, an amount of the data exposure points, a type of the data exposure points, and the security policies;
generating, by the system, the privacy audit report for the web application that comprises the risk score, an inventory of data types, an inventory of the data exposure points, and a graphical representation of historical risk scores; and
transferring, by the system, the privacy audit report for delivery to an operator of the web application.

9. The method of claim 8 wherein:
identifying data exposure points in the web application comprises identifying first-party scrips that access the data in the web application and identifying third-party scrips that access the data in the web application; and
generating the risk score for the web application based on the amount of the data exposure points comprises generating the risk score based on a total amount of the first-party scrips and the third-party scrips scripts that have access to the data.

10. The method of claim 8 wherein:
identifying data exposure points in the web application comprises identifying first-party scrips that access the data in the web application and identifying third-party scrips that access the data in the web application; and
generating the risk score for the web application based on the type of the data exposure points comprises generating the risk score based on an amount of the first-party scripts and an amount of the third-party scripts.

11. The method of claim 8 wherein:
identifying data exposure points in the web application comprises identifying first-party scrips that access the data in the web application and identifying third-party scrips that access the data in the web application; and wherein:
generating the risk score for the web application further comprises determining evidence of data access for the first-party scripts and evidence of data access for the third-party scripts based on data flow analysis, a co-presence of the data and the first-party scripts on the web application, and a co-presence of the data and the third-party scripts on the web application and generating the risk score based on the evidence of data access.

12. The method of claim 8 wherein:
generating the risk score for the web application based on the sensitivity of the data comprises determining the types for the data, generating a sensitivity score for the data based on the data types, and generating the risk score based on the sensitivity score.

13. The method of claim 8 wherein:
generating the risk score for the web application based on the security policies comprises determining which of the security policies are applied by the web application, determining a quality of the security policies, and generating the risk score based on which of the security policies are applied and the quality of the security policies.

14. The method of claim 8 wherein:
generating the risk score for the web application based on the amount of the data, the sensitivity of the data, the amount of the data exposure points, the type of the data exposure points, and the security policies comprises executing a weighted sum function to generate the risk score.

15. A non-transitory computer-readable medium stored thereon instructions to generate a privacy audit report for a web application that, in response to execution, cause a system comprising a processor to perform operations, the operations comprising:
crawling the web application;
identifying data in the web application;
identifying data exposure points in the web application;
identifying security policies implemented by the web application;
generating a risk score for the web application based on an amount of the data, a sensitivity of the data, an amount of the data exposure points, a type of the data exposure points, and the security policies;
generating the privacy audit report for the web application that comprises the risk score, an inventory of data types, an inventory of the data exposure points, and a graphical representation of historical risk scores; and
transferring the privacy audit report for delivery to an operator of the web application.

16. The non-transitory computer-readable medium of claim 15, the operations further comprising:
identifying first-party scrips that access the data in the web application;
identifying third-party scrips that access the data in the web application; and
generating the risk score based on a total amount of the first-party scrips and the third-party scrips scripts that have access to the data.

17. The non-transitory computer-readable medium of claim 15, the operations further comprising:
identifying first-party scrips that access the data in the web application;
identifying third-party scrips that access the data in the web application; and
generating the risk score based on an amount of the first-party scripts and an amount of the third-party scripts.

18. The non-transitory computer-readable medium of claim 15, the operations further comprising:
identifying first-party scrips that access the data in the web application;
identifying third-party scrips that access the data in the web application;
determining evidence of data access for the first-party scripts and evidence of data access for the third-party scripts based on data flow analysis, a co-presence of the data and the first-party scripts on the web application, and a co-presence of the data and the third-party scripts on the web application; and
generating the risk score based on the evidence of data access.

19. The non-transitory computer-readable medium of claim 15, the operations further comprising:
determining the types for the data;
generating a sensitivity score for the data based on the data types; and
generating the risk score based on the sensitivity score.

20. The non-transitory computer-readable medium of claim 15, the operations further comprising:
determining which of the security policies are applied by the web application;
determining a quality of the security policies; and
generating the risk score based on which of the security policies are applied and the quality of the security policies.
